(19) United States
(12) Patent Application Publication
(10) Pub. No.: US 2011/0156478 A1
(43) Pub. Date: Jun. 30, 2011

(54) SYSTEM AND METHOD FOR CORD MANAGEMENT

(75) Inventors: Roy C. Thorsell, Clawson, MI (US); Thomas A. Miller, Royal Oak, MI (US)

(73) Assignee: TOYODA GOSEI CO. LTD., Gun Aichi (JP)

(21) Appl. No.: 12/970,241

(22) Filed: Dec. 16, 2010

Related U.S. Application Data
(60) Provisional application No. 61/329,696, filed on Apr. 30, 2010.
(60) Provisional application No. 61/326,893, filed on Apr. 22, 2010.
(60) Provisional application No. 61/290,352, filed on Dec. 28, 2009.

(51) Int. Cl. H02G 3/00

(52) U.S. Cl. 307/9.1

(57) ABSTRACT

The present invention relates to a cord management system comprising: a vehicle comprising: (a) an upper opening in a dashboard; (b) a lower opening in the base of the dashboard or in a center console; (c) a sleeve attached to and extending from the upper opening to the lower opening; and (d) a power source, jack, port, or combination thereof located inside or adjacent to the lower opening.

### CLAIM OF BENEFIT OF FILING DATE

The present application claims the benefit of the filing date of U.S. Provisional Application Nos. 61/290,352, filed Dec. 28, 2009; 61/326,893, filed Apr. 22, 2010; and 61/329,696, filed Apr. 30, 2010; the contents of which are hereby expressly incorporated by reference.

### FIELD OF THE INVENTION

The present invention relates generally to a system and method for managing cords of portable electronic devices, which are used in a vehicle.

### BACKGROUND OF THE INVENTION

Electronic devices for use in a vehicle are common place. Many of these electronic devices contain an internal power source. However, when the electronic devices are used outside of the vehicle or inside of the vehicle for extended periods of time it often becomes necessary to recharge the internal power source or use the vehicle's power to run the electronic device. In order to charge and run the electronic devices a power cord is employed. The power cord runs from the electronic device to a power source in the car. The electronic devices also may employ cords for attachment and use with the vehicle (e.g. connecting an MP3 player to the vehicle's radio and speaker system or connecting a cell phone to the speakers and microphone of the car for hands free use). Often these cords becomes tangled and knotted with extended use. These problems are exacerbated when multiple electronic devices and their cords are in use or the electronic devices are mounted to the windshield, the dashboard, instrument panel, or center console of the vehicle. When windshield, dashboard, or center console mounted devices are employed the cords hang down over a portion of the windshield, dashboard, other controls of the car, or a combination thereof. The cords are a possible safety hazard as they can get tangled with other parts of the car such as a shifter or require the driver to take their eyes off of the road to untangle the cord so that it can be plugged in or used. The cords also make the vehicle look messy as the cords are always in sight. Some systems have attempted to solve this problem. Examples of such systems are disclosed in Cotton (U.S. Pat. No. 6,179,253), Postrel (U.S. Patent Publication No. 2004-0121645), Postrel (U.S. Patent Publication No. 2005-0277322), Cvetko (U.S. Patent Publication No. 2006-0181840), and Lourdes (European Patent Application No. EP2042377), all incorporated by reference herein.

What is needed is a system which allows the electronic devices to be recharged or used without interference to the driver's vision and safety, tangling of cords, and unsightly cords hanging over the dashboard. What is further needed is a system, which allows the electronic devices to be charged or used without interference to the driver, while reducing the clutter inside the vehicle.

### SUMMARY OF THE INVENTION

The present invention meets one or more of the above needs and is a cord management system comprising: a vehicle further comprising: (a) an upper opening in a dashboard; (b) a lower opening in the base of the dashboard and/or in a center console; (c) a sleeve attached to and extending from the upper opening to the lower opening; and (d) a power source, jack, port, or a combination thereof located inside or adjacent to the lower opening. In a preferred embodiment, the cord management system and method are adapted for use in an automobile.

In another embodiment, the invention is an instrument panel for use in a vehicle comprising: (a) an upper opening; (b) a lower opening; and (c) a sleeve attached to and extending from the upper opening to the lower opening.

Another embodiment of the invention is a method of using a cord management system or an instrument panel for use in a vehicle comprising: (a) placing an electronic device in close proximity to an upper opening in a dashboard; (b) placing a cord of the electronic device through a sleeve located inside or near a lower opening of the dashboard; and (c) plugging the cord into a power source, jack, port, or a combination thereof.

The system and method for cord management allows electronic devices to be used or charged without cords moving freely about a vehicle's cabin. The system and method for cord management makes using the electronic devices safer and removes the unsightly nature of cords hanging over the dashboard.

### DESCRIPTION OF THE DRAWINGS

FIG. 1 illustrates a vehicle dashboard containing the cord management system;

FIG. 2 illustrates a close up view of the cord management system;

FIG. 3 illustrates a vehicle dashboard and center console containing the cord management system;

FIG. 4 illustrates a close up view of one embodiment of the cord management system; and

FIG. 5 illustrate an example of one cradle that may be used with the power cord management system.

### DETAILED DESCRIPTION

The invention relates to a system that allows cords of electronic devices to be plugged into an electronic device and a power source, jack, port, outlet, or a combination thereof without interference to the user. The system as used herein means any system where a portable electronic device may be plugged into a power source, jack, port, outlet, or a combination thereof and used. The system may be used in a vehicle (e.g. a car, boat, airplane, motorcycle, or the like). Preferably the vehicle is an automobile.

In one embodiment, the system is in a vehicle and is adapted to perform one or more of the following functions: the power source is capable of powering an electronic device; the power source is a cigarette lighter outlet; the power source is a standard 110V outlet; the port is a USB port; the system is adapted to allow a power cord to be placed through the upper opening and into the lower opening and plugged into the power source; the upper opening includes a door; the door of the upper opening is configured to have an open position and a closed position such that when the door is in the closed position the dashboard does not appear to contain an opening; an attachment module is located under the upper dashboard door for holding devices in place and guiding the wires through the sleeve; the attachment module seats in the upper opening; the sleeve is large enough that a standard cigarette lighter power cord, a standard 110v power cord, or both can slide through the sleeve and provide a direct path to the power source; the power cord is not visible to the driver or passengers when the power cord management system is in use; the door of the upper opening is spring loaded; the spring moves the door of the upper opening to a position that does not interfere with the use of the power cord management system; the attachment module is removable so that a different attachment module can be installed to accommodate different electronic devices; the sleeve is large enough to accommodate two or more power cords simultaneously; or a combination thereof.

In another embodiment, the system is an instrument panel which is adapted to perform one or more of the following functions: further including a power source; the power source is capable of powering an electronic device; the power source is a cigarette lighter outlet; the power source is a standard 110V power plug; the instrument panel is adapted to allow a power cord to be placed through the upper opening and into the lower opening and plugged into the power source; upper opening includes a door; the door of the upper opening is configured to have an open position and a closed position such that when the door is in the closed position the dashboard does not appear to contain an opening; an attachment module is located under the upper dashboard door for holding devices in place and guiding the wires through the sleeve; the sleeve is large enough that a standard cigarette lighter power cord, a standard 110v power cord, or both can slide through the sleeve and provide a direct path to the power source; the power cord is not visible to the driver or passengers when the power cord management system is in use; the door of the upper opening is spring loaded; the attachment module is removable so that a different attachment module can be installed to accommodate different electronic devices; the sleeve is large enough to accommodate two or more power cords simultaneously; or a combination thereof.

In another embodiment, the device is a vehicle component comprising: a first opening, a second opening, and an alley extending from the fist opening to the second opening so that a cord can be placed in the alley. The component is capable of performing one or more of the following functions: further comprising an outlet located juxtaposed to the second opening; further comprising a cover located over the alley such that the cover is capable of hiding the wires that are placed in the alley; the cover is moveably attached so that the cover can be moved when cords are placed in the alley; a storage tray is located juxtaposed to the fist opening; the storage tray is on a link track and is capable of rotating; the storage try is capable of being stored inside the vehicle component; or a combination thereof.

In another embodiment, the system may be used in a process by a user performing one or more of the following steps: connecting the electronic device to either a windshield or an attachment module; placing the power cord of a second electronic device through the power cord sleeve; the power source is a cigarette lighter outlet.

The system comprises a dashboard, which functions as the housing for all or a majority of the system. The dashboard may act to support the electronic device or may be located in close proximity to an electronic device attached to the windshield, a portion of the dashboard, or the like.

The dashboard further includes an upper opening which allows cords of the electronic devices to pass into the dashboard. Preferably, the upper opening will be formed when the dashboard is made. The upper opening may be located in the center of the dashboard, on the driver's side of center of the dashboard, on the passenger's side center of the dashboard, or any other location along the dashboard. The upper opening may be of any size and shape. Preferably, the upper opening will be large enough to fit a standard 110V plug or a plug used with a cigarette lighter. The upper opening may be large enough to seat the optional attachment module, holder, or both. The upper opening may have a length (L) and a width (W).

The upper opening may include a door (e.g. a cover or the like). The door may include an open position and a closed position. The door may be closed when the power cord management system is not in use. Preferably, when the door is in the closed position the door will not be noticeable (i.e. the door and dashboard will look like one continuous piece). The door may include an assist opening device, assist closing device, or both. The assist device should operate such that it is strong enough to move the door (i.e. open, close, or both) but not so strong so that the user will have trouble moving the door (i.e. opening, closing, or both). Any device that assists in moving the door may be employed. The assist device may be a spring (e.g. cantilever spring, coil spring, volute spring, tension spring, spiral hair spring, or the like); a piston; a servo motor; gears; or the like. Preferably, a spring will be used as a cantilever to move the door. The door may open up such that all or a portion of the door will rise above the dashboard. Preferably, the door will open down such that all or a portion of the door travels down towards or into the sleeve and/or an alley. The door may also be a tambour door. The door may be left in the open position when the system is in use. The door when in the open position may not contact the cord. Preferably, the door, when in use, may be in a semi-closed position. The door when in the semi-closed position may contact the cord and may be held slightly open by the cord. It is further contemplated that the door may be used to support the electronic device. The door may include an attachment feature or device cradle. The door may be designed so that attachment devices may be attached to the door. For example, the door may have a smooth side so that the electronic device may stick to the door using a suction cup.

The dashboard may further include a lower opening. The lower opening may also be located in the center console. Preferably, the lower opening will be part of the dashboard. Preferably, the lower opening will be formed when the dashboard is made. The center console may be attached to the dashboard or be an extension of the dashboard. The lower opening may include a door. The lower opening may include any door, door configuration, or cover described herein for use with the upper opening. Preferably, the lower opening will not include a door or cover. The lower opening may be of any size and shape. Preferably, the lower opening will be large enough to fit a standard 110V plug or plug for use with a cigarette lighter. The lower opening may be suitably sized so that the user can reach into the opening to grasp the cord and plug the cord into the power source, jack, port, or a combination thereof. The lower opening may be large enough so that the user can reach into the opening to assist the cord through the sleeve into the lower opening. The lower opening may have a length (L) and a width (W). The second lower opening may further include a second lower opening. The second lower opening may include a door or cover. The second lower opening may not include a door or cover. The second lower opening may be suitably sized so that the user can reach into the opening to grasp the cord and plug the cord into the power source, jack, port, or a combination thereof. Preferably, the second lower opening will be large enough to fit a standard 110V plug or plug for use with a cigarette lighter. The second lower opening may have a length (L) and a width (W). The second lower opening may allow the user access to the vehicle's electrical system (e.g. the radio). For example, the user may be able to plug a USB cord from an MP3 player directly into a USB port in the vehicle's radio by passing the cord through the second lower opening.

The dashboard may comprise a passage. The passage (e.g. an alley) may be any area that spans from a first opening (i.e. upper opening) to a second opening (i.e. lower opening). The passage and/or alley may further include a sleeve. The dashboard may further comprise a sleeve. Preferably, the passage includes a sleeve. The sleeve extends from the upper opening to the lower opening. The sleeve is attached to the upper opening and the lower opening. The sleeve may be any shape. The length of the sleeve may vary from vehicle to vehicle (e.g. a compact car may have a shorter sleeve than a truck). The inside dimension of the sleeve may stay one constant dimension for the length of the sleeve. Preferably, the inside dimension of the sleeve will taper and become smaller as the sleeve approaches the lower opening. Preferably, the sleeve is large enough that a standard 110v power plug or a plug for use with cigarette lighter can fit in the sleeve. The sleeve may be straight. The sleeve may be arcuate. The arc of the sleeve may be slight so that the sleeve connects the upper opening to the lower opening, while facilitating movement of the plug down the sleeve. The sleeve may be substantially round, square, octagonal, or a combination thereof. The sleeve may include a slit so that wires may be pushed through the slit into the sleeve or pulled out of the sleeve through the slit.

The sleeve may be made of any material. The sleeve may be made of a material that is smooth so that the cord may easily slide from the upper opening to the lower opening. The sleeve may be made of any material that is capable of use in a blow molding process. The sleeve may be made of polyvinyl chloride, a polyolefin (e.g. polyethylene or a polycarbonate), polypropylene, acrylonitrile/butadiene/styrene blend, or the like. The sleeve may be made of the same material as the dashboard, instrument panel, the center console, combinations thereof. The sleeve may be made of a different material than the dashboard, instrument panel, center console, or a combination thereof. The sleeve may be large enough so that one or more cords can pass through the sleeve.

The sleeve and dashboard, instrument panel, or the center console may be one piece. The sleeve may be made separately and attached to the dashboard, instrument panel, or the center console. The sleeve may be attached using any suitable attachment device or method. The sleeve may be attached using a mechanical device (e.g. screw, fastener, rivet, or the like), the sleeve may be attached using a chemical device (e.g. adhesive, bonding agent, or the like), or the sleeve may be attached by permanently joining the sleeve to the upper opening and the lower opening (e.g. polymer welding, melting, or the like).

The dashboard may further comprise a power source. The power source may also be located in the center console or any other console in close proximity with the dashboard. The power source and lower opening may be juxtaposed. Preferably, the power source will be located inside of the lower opening, which is part of the dashboard. The power source can be any power source suitable for charging or running electronic devices. The power source may be a cigarette lighter outlet, a 110 v outlet, or the like. Preferably, the power source will be a cigarette lighter outlet. The electronic device may be hardwired into the car. Preferably the electronic devices use a power cord so that electronic devices can be easily removed or replaced with different devices.

The dashboard may further comprise a jack or port. The jack or port may be located in the center console or any other console in close proximity with the dashboard. The jack or port and lower opening may be juxtaposed. Preferably, the jack or port will be located inside of the lower opening, which is part of the dashboard. The jack or port may be any connector suitable for use with electronic devices. For example, the jack or port may be adapted for use with a USB, mini USB, MP3 connection, fire wire, or the like. Preferably, the jack or port will be a USB port.

The dashboard may further include an attachment module or device cradle. The attachment module may be part of the door or cover. The attachment module may be part of the upper opening. The attachment module may be located or stored inside the upper opening such that the door can close and the attachment module will be concealed. The attachment module may seat and lock inside the upper opening. The attachment module may seat in the upper opening so that the attachment module holds the electronic device in place and allows the user to visually see the electronic device, its buttons, and still access the buttons. The attachment may be any module suitable for attaching electronic devices for charging, use, or both. The attachment module may be adaptable for different electronic devices. The attachment module may allow attachment of manufacturers charging and playing stands. The attachment module may include an aperture so that cords can pass into the upper opening. The size of the upper opening may be large enough so that an attachment module may be used, stored, locked into place, or a combination thereof. The upper opening may be large enough so that the attachment module may be stored inside of the upper opening. The upper opening may have a length (L′), a height (H′), and a depth (D′). The attachment module may be a holder that is adaptable to fit different devices. The holder may be placed into the upper opening. The holder may lock into the upper opening. The holder may include arms that adjustably grip the sides of an electronic device. The holder may include one or more arm that press against the face or a portion of the face of the electronic device. The one or more arm may press a portion of the face and not impede use of the device. The holder may include an aperture so that the cords can pass through the holder to the electronic device from the power source, jack, port, or a combination thereof. The holder may be adjustable so that the electronic device can swivel to be viewed by the driver or the passenger.

The cord management system may be sold as a kit and installed into the dashboard of a vehicle. Preferably, the cord management system will be part of the dashboard when the dashboard is manufactured.

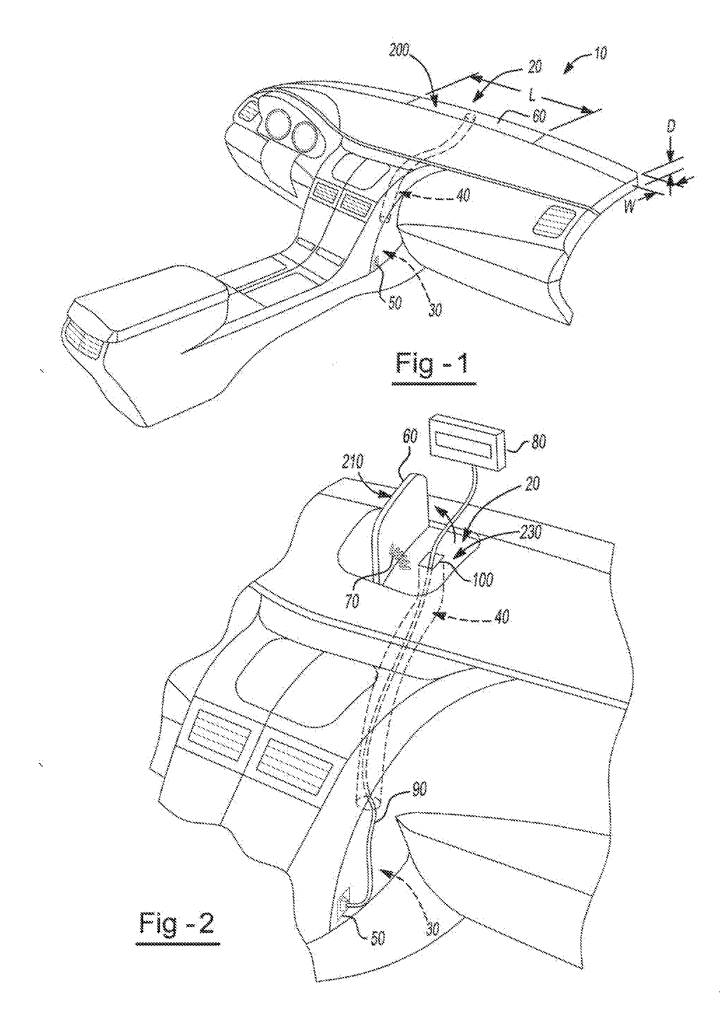

The following description of the figures is provided to aid in the understanding of the claimed invention. The description is not meant to limit the scope of the claims to which the inventors are entitled. As illustrated in FIGS. 1-2, the present invention includes a dashboard (10), which is comprised of an upper opening (20), a lower opening (30), a sleeve (40), and a power source (50).

FIG. 1 illustrates the present invention with a door (60). The door (60) as illustrated in FIG. 1 is in the closed position (200) and forms one continuous piece with the dashboard.

FIG. 2 is a close up view of the upper opening (20), the lower opening (30), and further illustrates the door (60) in the open position (210). The door (60) further includes a spring (70). Also illustrated is an electronic device (80) that may be used in conjunction with the cord management system. The electronic device includes a power cord (90) that is plugged into the electronic device (80) passing through the upper opening (20), the passage (230), and the sleeve (40) where it enters the lower opening (30) and is plugged into the power source (50). FIG. 2 further includes an attachment module (100) so that the electronic device can be attached and placed in the upper opening (20).

The system comprises an instrument panel. The instrument panel may be separate from a vehicle. The instrument panel may include an upper opening, a lower opening, and a sleeve. The instrument panel may include a power source, jack, port, or combination thereof so that when the instrument panel is connected to a vehicle the power source, jack, port, or combination thereof can be attached to the vehicle and used. The upper opening and the lower opening are connected by the sleeve. The instrument panel may include any dimensions, characteristics, or descriptions used herein to describe the dashboard.

A component may be any device capable of holding an electronic device that employs a cord or wire that is plugged into a jack, outlet, power source, port, or the like. Preferably, the component will be a part used in the interior of a vehicle. The component may be a center console, an instrument panel, all or a portion of an arm rest, all or a portion of the dashboard, may be any part located between the driver seat and the passenger seat, any part located between the front seats and rear seats, or a combination thereof. The component may include any dimensions, characteristics, or descriptions used herein to describe the dashboard, instrument panel, control panel, or combinations thereof.

A component may be capable of performing the same functions as the dashboard, without necessarily being located in front of a user. The component may include more than one cord system as described herein (i.e. one on the passenger side of a component and one on the driver side of a component). The component may include a first opening. The first opening may allow the user to place an electronic device in close proximity to the first opening so that cords can be placed into the first opening.

The component may further include an alley and/or a sleeve. Preferably, the alley will be a wire alley. The alley may be attached to the first opening. The alley may be in close proximity to the first opening so that any cord or wire placed into or through the first opening will pass into the alley. The alley may include a sleeve for housing the cords. The alley may be large enough to accommodate one or more cords. Preferably, the alley will be large enough to accommodate a standard cork screw shaped power cord. The alley may include a cover or a door.

The cover may be fixedly attached to the component. The cover may be removably attached to the component. The cover may be attached by any device capable of allowing the user to temporarily move or remove the cover to facilitate positioning of wires or cords in the alley, first opening, second opening, or a combination thereof. Preferably, the cover will be hingedly attached to the component so that the user can open the cover to facilitate movement of the cords through the first opening down the alley and into a second opening. The cover may be attached to the component using hinges, latches, tracks, or the like. The cover may include a device to hold the cover in the closed position. The cover may be held in place by any device capable of securing the cover in the closed position. The cover may be held in place by a lock, a latch, a magnet, a snap fit, a spring, or the like.

The component may include a second opening. The second opening may allow the user to access a cord or wire placed in the alley. The second opening may be located near an outlet, power source, jack, port, or the like.

The component may be used with an attachment unit, a cradle, or both. Examples of possible attachment trays that may be used with the present invention may be found in U.S. Provisional Application No. 61/326,893 the teachings of which are incorporated by reference herein. The attachment unit and/or cradle may hold one or more electronic devices. The attachment unit may include a cradle. The cradle may be an integral component of the attachment unit. The cradle may be a separable component of the attachment unit. The cradle may perform any of the functions described herein for the attachment unit. The attachment unit may be stationary. The attachment unit may be movable. The attachment unit may be on any device capable of moving the attachment unit into the user space and into a storage unit located in the component, dashboard, center console, instrument panel, arm rest, or the like. The component may be used in conjunction with the attachment module or device cradle previously described herein.

The attachment unit may rotate so that the user may more easily view the electronic devices. The attachment unit may be rotated by any device capable of rotating the attachment unit. The rotation may be performed by a hinge, a pivot, a ball, a wheel, or the like. The attachment device may rotate from side to side. The attachment device may rotate up and down. The attachment device may be moved from a flat horizontal position to a vertical position. The attachment unit may be capable or rotating more than about 10 degrees, more than about 20 degrees, more than about 40 degrees, or even more than about 50 degrees (e.g. about 30 degrees).

The attachment unit may have an open position and a closed position. The open position may be when the unit is extended into the user space. The closed position may be when the unit is retracted into the component, dashboard, center console, instrument panel, arm rest, or the like. The attachment unit may include a face that matches the appearance of which ever part the unit is retracted into so that the attachment unit is not easily visible when in the closed position. The attachment unit may be covered by a separate door. The door may move up into the part so that the attachment unit can be moved. The attachment unit may include a lock out feature. The lock out feature may lock the tray so that it cannot be closed when the tray is in a rotated position. The lock out may be capable of first moving the tray back into a safe position before the tray can be closed.

The attachment module may be held in the upper opening by any method for securing one device to another. For example, the upper opening may include a female portion and the attachment module may include a male portion or vice versa. The upper opening may include a hole so that the attachment module can fit in the hole and be securely held in place. The hole in the upper opening and the attachment module may form an interference fit. The attachment module may include a locking device that may hold the attachment module in place (e.g. a detent, a compressible ball bearing, a spring loaded clip, or the like).

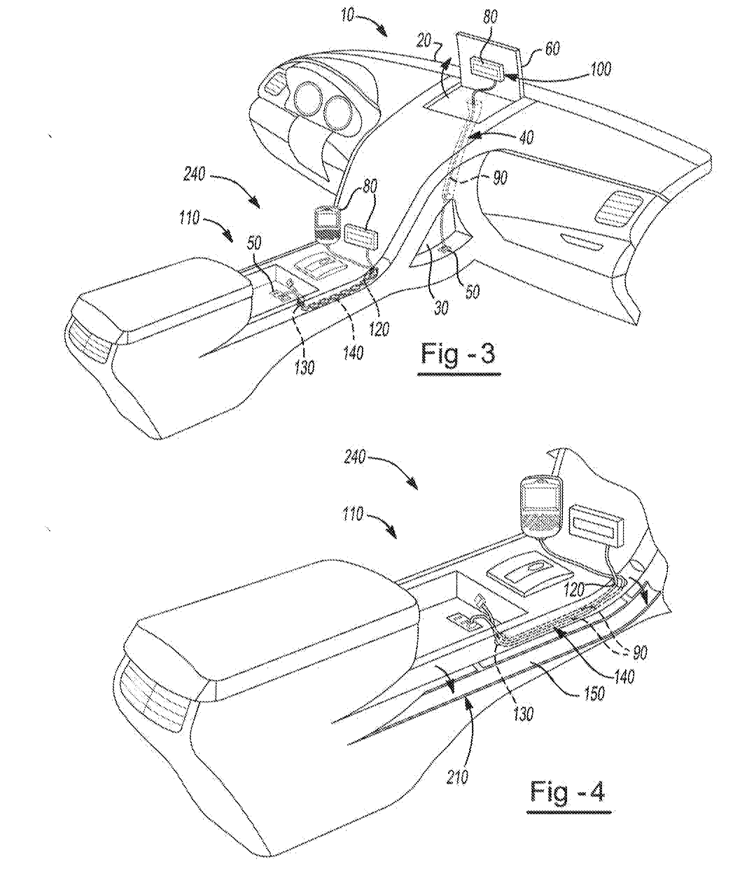

FIG. 3 illustrates the present invention in two possible vehicle locations. A dashboard (10) device is illustrated, including the upper opening (20), lower opening (30), sleeve (40), and power source (50). The door (60) is illustrated using an attachment device for holding the electronic device in place. FIG. 3 also illustrates use with a component (110), and the component is a center console (240). The component includes a first opening (120), a second opening (130), an alley (140), and a cover (150). Multiple power sources (50), and electronic devices (80) are shown.

FIG. 4 illustrates a close up view of the component (110). The vehicle component is a center console (240). As shown the cover (150) is in the open position (210) exposing the alley (140), power cord (90), first opening (120), and second opening (130). As illustrated a two power cords (90) have been placed through the first opening (120) into the alley (140) through the second opening (130), and is near the power source (50).

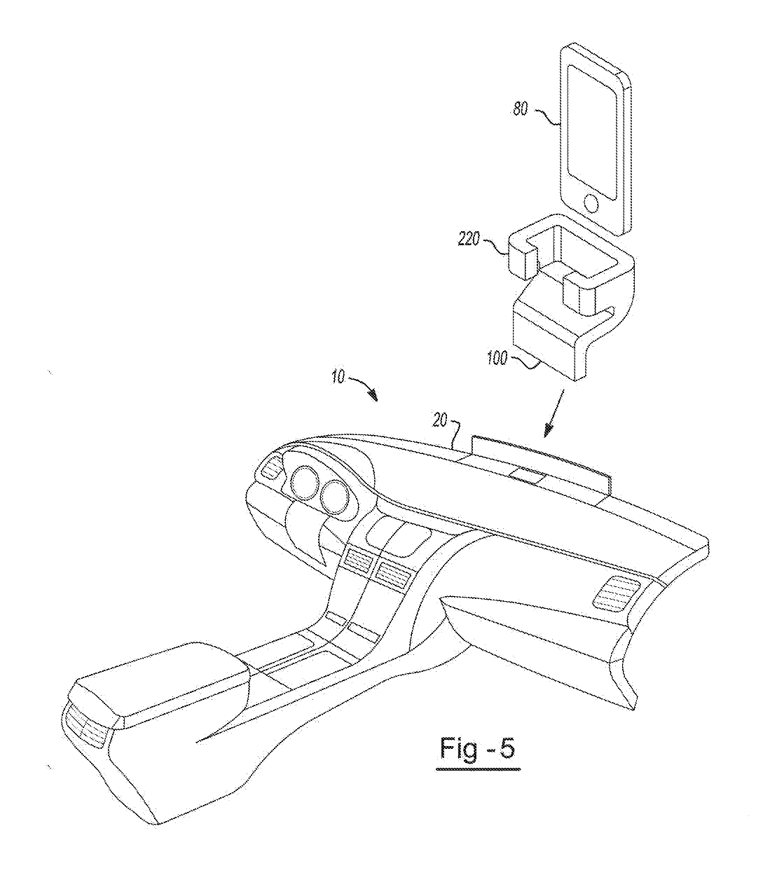

FIG. 5 illustrates one example of a cradle (220) that may be used to hold an electronic device (80). The cradle (220) as illustrated is one example of a cradle (220) that is integral with an attachment module (100). The upper opening (20) may include any opening or attachment part so that the attachment module (100) may be secured in the upper opening.

The present invention may further provide a method (e.g. process) for using a cord management system. For example, the cord management system may include placing an electronic device in close proximity to an upper opening, placing a cord through a sleeve, and plugging the electronic device into a power source, jack, port, or combination thereof located inside or near a lower opening. The steps may be repeated if more than one device is employed or if the device is removed and then placed back in the power cord management system.

The step of placing an electronic device in close proximity to an upper opening may include, attaching the electronic device to a windshield, an attachment module, a dashboard, an instrument panel, or any other place in close proximity to the upper opening.

The step of placing a power cord through a sleeve may include opening a door of the upper opening, lower opening, or both and placing a cord into the sleeve and allowing the cord to travel from the upper opening to the lower opening. The cord may travel from the upper opening to the lower opening using only gravity. The upper opening, lower opening, or both may be large enough that the user can assist in moving the cord through the sleeve. The method may further include a step of monitoring the power cord as it passes through the sleeve so that it does not become stuck in the sleeve.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1. A system comprising:
a vehicle component comprising:
i. an first opening the vehicle component;
ii. a second opening in the vehicle component;
iii. a passage including a sleeve attached to and extending from the first opening to the second opening; and
iv. a power source, jack, port, or combination thereof located inside or adjacent to the second opening.

2. The system of claim 1, wherein the power source is capable of powering an electronic device.

3. The system of claim 2, wherein the power source is a cigarette lighter outlet, a standard 110V power plug, a USB port, or a combination thereof.

4. The system of claim 1, wherein the system is adapted to allow a power cord to be placed into the first opening, through a sleeve, into the second opening, and plugged into the power source.

5. The system of claim 1, wherein the first opening includes a door, and the door has an open position and a closed position such that when the door is in the closed position the vehicle component does not appear to contain an opening.

6. The system of claim 5, further comprising an attachment module located under the door of the vehicle component for holding devices in place and guiding the wires through the sleeve.

7. The system of claim 1, wherein the sleeve is large enough that a standard cigarette lighter power cord, a standard 110v power cord, or both can slide through the sleeve and provide a direct path to the power source.

8. The system of claim 1, wherein the power cord is not visible to the driver or passengers when the power cord management system is in use.

9. The system of claim 5, wherein the door includes a spring.

10. The system of claim 6, wherein the attachment module is removable so that a different attachment module can be installed to accommodate different electronic devices.

11. The system of claim 7, wherein the sleeve is large enough to accommodate two or more power cords simultaneously.

12. The system of claim 1, further comprising a storage tray located juxtaposed to the first opening.

13. The system of claim 12, wherein the storage tray is on a link track and is capable of rotating.

14. The system of claim 13, wherein the storage tray is capable of being stored inside the vehicle component.

15. The system of claim 1, wherein the vehicle component is a dashboard, an instrument panel, a center console, or a combination thereof.

16. The system of claim 15, wherein the first opening includes a door and the door includes an assist opening device for moving the door, and
an attachment module that is removable so that a different attachment module can be installed to accommodate different electronic devices.

17. A method comprising:
i. placing an electronic device in close proximity to a first opening in a vehicle component;
ii. placing a power cord of the electronic device through a power cord sleeve located inside the vehicle component; and
iii. plugging the power cord into a power source, jack, port, or a combination thereof.

18. The method of claim 17, wherein the power source is a cigarette lighter outlet.

19. The method of claim 18, further comprising connecting the electronic device to either a windshield or an attachment module.

20. The method of claim 19, further comprising placing the power cord of a second electronic device through the power cord sleeve.
